(19) United States
(12) Patent Application Publication
(10) Pub. No.: US 2011/0298932 A1
(43) Pub. Date: Dec. 8, 2011

(54) SYSTEMS AND METHODS FOR CONCEALED OBJECT DETECTION

(75) Inventors: Izrail Gorian, Watertown, MA (US); Galina Doubinina, Watertown, MA (US)

(73) Assignee: ISCON VIDEO IMAGING, INC., Woburn, MA (US)

(21) Appl. No.: 13/175,116

(22) Filed: Jul. 1, 2011

Related U.S. Application Data
(63) Continuation-in-part of application No. 12/648,518, filed on Dec. 29, 2009.
(60) Provisional application No. 61/141,745, filed on Dec. 31, 2008.

(51) Int. Cl. H04N 5/30

(52) U.S. Cl. 348/164; 348/162; 348/E05.09

(57) ABSTRACT

A system including an image acquisition subsystem receiving electromagnetic radiation from a body, a spectral decomposition subsystem separating the received electromagnetic radiation into at least a number of predetermined spectral components, each one component from the number of predetermined components corresponding to a response to a non-visible analogue to a visible spectrum representation of the predetermined spectral components, a wavelength of the received electromagnetic radiation being in a non-visible range, and an analysis subsystem receiving the at least the number of predetermined components, identifying at least one region in an image obtained from at least one the number of predetermined components and providing a color image, the color image obtained from the visible spectrum representation of the non-visible analogue; the at least one region of the color image enabling detection of a concealed object.

### CROSS REFERENCE TO RELATED APPLICATIONS

This application is a continuation in part of U.S. patent application Ser. No. 12/648,518 (Attorney Docket No. 31933-104), entitled “SYSTEMS AND METHODS FOR CONCEALED OBJECT DETECTION,” filed on Dec. 29, 2009, which claims priority of U.S. Provisional Application 61/141,745 (Attorney Docket No. 31933-104), entitled “SYSTEMS AND METHODS FOR CONCEALED OBJECT DETECTION,” filed on Dec. 31, 2008, both which are incorporated by reference herein in its entirety for all purposes.

### BACKGROUND

These teachings relate generally to detecting concealed objects, and, more particularly, to detecting concealed objects utilizing radiation in a predetermined range of wavelengths.

An infrared camera can see the environment based on temperature difference between neighbor elements of the image. For example, cold object on the warm background could be seen on the monitor connected to the infrared camera as black spot on the white background. An Object under cloth also could be visible if object is cold enough compared to the body temperature. If the object under cloth is in contact with the cloth for a sufficiently long period of time, the body transfers heat to the cloth and the object and eventually the object will be almost indistinguishable (invisible) or more accurately, the object is losing its visibility or contrast in the infrared. The less sensitive an infrared device, the faster the object loses its visibility.

However, temperature between the object and cloth background will never be theoretically equal because of different thermal conductivity of an object and cloth. A temperature difference exists even the object on the body is located for any length of time. This difference could be negligible for today's devices to reveal such objects under cloth. For example, advanced cameras with thermal resolution not better than 20 mK cannot see real objects under the cloth if the object is in contact with the body for about 10 minutes or more.

### BRIEF SUMMARY

In one embodiment, the system of these teachings includes an image acquisition subsystem receiving electromagnetic radiation from a body, a spectral decomposition subsystem separating the received electromagnetic radiation into at least a number of predetermined spectral components, each one component from the number of predetermined components corresponding to a response to a non-visible analogue to a visible spectrum representation of the predetermined spectral components, a wavelength of the received electromagnetic radiation being in a non-visible range, and an analysis subsystem receiving the at least the number of predetermined components, identifying at least one region in an image obtained from at least one the number of predetermined components and providing a color image, the color image obtained from the visible spectrum representation of the non-visible analogue; the at least one region of the color image enabling detection of a concealed object.

In one instance, the system of these teachings includes an image acquisition subsystem receiving electromagnetic radiation from a body, a spectral decomposition subsystem separating the received electromagnetic radiation into at least three components, each one component of three of the at least three components corresponding to a response to a non-visible analogue to one human vision spectral response from three human vision spectral responses and an analysis subsystem receiving the at least three components, identifying at least one region in an image obtained from at least one the at least three components and providing a color image, the color image obtained from a visible equivalent of the non-visible analogue; the at least one region of the color image enabling detection of a concealed object. The responses of the detector to each of the images are utilized to provide color signals to a display device (a monitor in one instance). The color image displayed in the display device allows identifying the concealed object.

In one instance, in practicing the method of these teachings, a number of images of a body having concealed objects are acquired, each image resulting in a response of a detector (or a detector and filter combination) having a spectral sensitivity substantially given by one of a number of predetermined spectral components, each one component from the number of predetermined components corresponding to a response to a non-visible analogue to a visible spectrum representation of said number of predetermined spectral components.

In one instance, the electromagnetic radiation is in the terahertz radiation range. In another instance the electromagnetic radiation is in the infrared range.

In one instance in practicing the method of these teachings, three nonvisible images of a body having concealed objects are acquired, each image resulting in a response of a detector having a spectral sensitivity that is analogous to one of the spectral sensitivities of the color response of the human eye, each image corresponding to a different spectral sensitivity. In one embodiment, the electromagnetic radiation is in a terahertz radiation range from about 0.2 Terahertz (THz) to about 5 THz in frequency, corresponding to a range from about 0.06 mm to about 1.5 mm in wavelength.

In one embodiment in which the number of spectral components is equal to three, at least the center of the spectral sensitivity corresponding to the Green response at the human eye (or the corresponding tristimulus response) is selected to allow increasing the detected radiation difference between the concealed object and the body. The responses of the detector to each of the three images are utilized to provide RGB signals to a display device (a monitor in one instance). The color image displayed in the display device allows identifying the concealed object.

Embodiments for different number of spectral components are disclosed herein below.

In another embodiment of the method, the image of substantially the body is extracted from the detected images.

Embodiments of systems that implement the methods of these teachings are also disclosed.

For a better understanding of the present teachings, together with other and further needs thereof, reference is made to the accompanying drawings and detailed description and its scope will be pointed out in the appended claims.

### BRIEF DESCRIPTION OF THE DRAWINGS

FIG. 1 shows the conventional spectral sensitivities of the of the cones;

FIG. 2 is a graphical representation of the spectral sensitivities showing a scale of near infrared wavelengths as well as the corresponding visual wavelengths imposed on the X axis;

FIGS. 2a, 2b and 2c are graphical representations of the spectral sensitivities showing a scale of terahertz radiation wavelengths as well as the corresponding visual wavelengths on the X axis, the figures being by the corresponding visual wavelength range (color);

FIG. 2d is a graphical representation of an embodiment in which the number of spectral components is seven;

FIG. 3 is a schematic graphical representation of an embodiment of a filter assembly of these teachings;

FIG. 4 is a schematic graphical representation of an embodiment of a system of these teachings;

FIGS. 5-8 represents results from an embodiment of the system of these teachings;

FIG. 9 is a schematic block diagram representation of an embodiment the image processing component of systems of these teachings;

FIG. 10 is a schematic block diagram representation of another embodiment the image processing component of systems of these teachings; and

FIGS. 11a-11c are graphical representations of the spectral characteristics of different explosives.

### DETAILED DESCRIPTION

Systems with sufficient resolution, having increased resolution compared to conventional systems, that are capable of detecting concealed objects, where the concealed objects have been in contact with a body and have achieved substantial Thermal equilibration with the body, are disclosed herein below.

Embodiments utilizing image processing in order to enhance the contrast in an image of the body and the concealed objects and embodiments utilizing a number of predetermined spectral components, each one component from the number of predetermined components corresponding to a response to a non-visible analogue to a visible spectrum representation of the number of predetermined spectral components are disclosed herein below.

In one instance, embodiments utilizing image processing in order to enhance the contrast in an image of the body and the concealed objects and embodiments utilizing an analogue, with three spectral components, of the spectral sensitivities of the cone types referred to as blue, green, and red cones, which are related to the tri-stimulus values in color theory (see, Color Vision, available at http://en.wikipedia.org/wiki/Color_vision#Theories_of_color_vision; Wyszecki, Günther; Stiles, W. S. (1982). Color Science: Concepts and Methods, Quantitative Data and Formulae (2nd ed. ed.). New York: Wiley Series in Pure and Applied Optics. ISBN 0-471-02106-7; R. W. G. Hunt (2004). The Reproduction of Colour (6th ed. ed.). Chichester UK: Wiley-IS&T Series in Imaging Science and Technology. pp. 11-12. ISBN 0-470-02425-9, all of which are incorporated by reference herein in their entirety) are within the scope of these teachings.

The human eye can distinguish about 10 millions of colors (by cones). It is known the eye can distinguish approximately 1000 grey levels (by rods). A color image could be preferable for distinguishing the objects from background. In some conventional systems, a pseudo color approach has been developed: each pixel of grey level image converted to the color based on brightness of the pixel. In those conventional systems, Different color pallets have been designed for different applications sometimes improving the ability to distinguish features but the improvement is not sufficient to distinguish concealed objects and the background. Conversion of gray level value to color has not achieved success in distinguishing concealed objects.

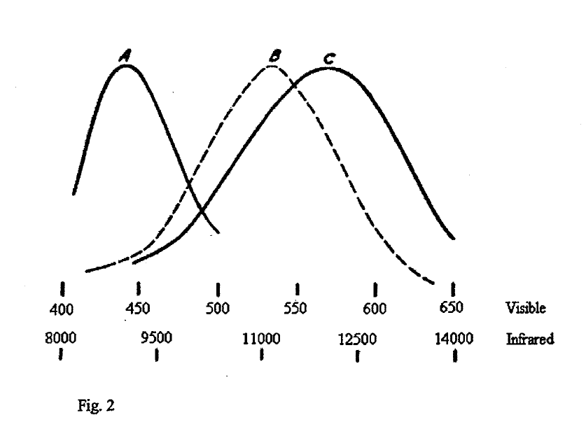

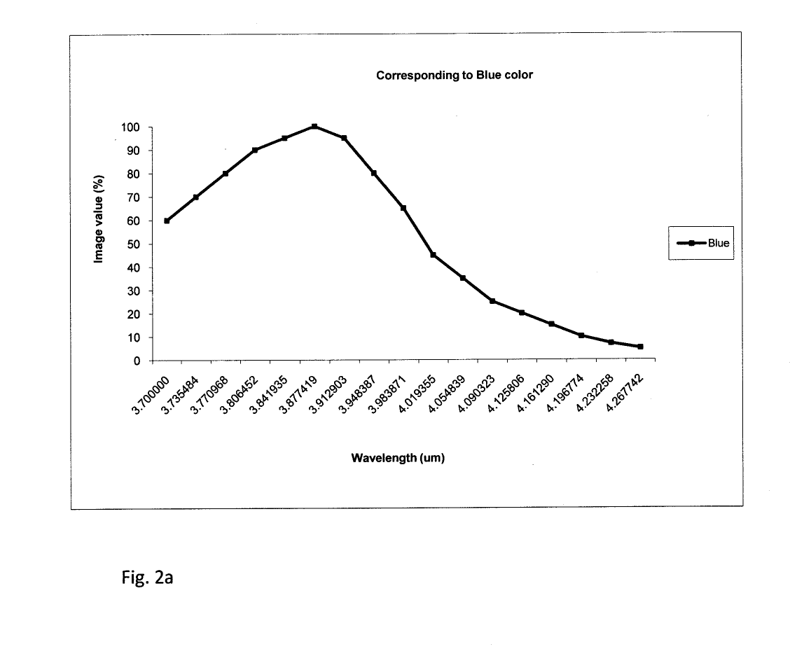

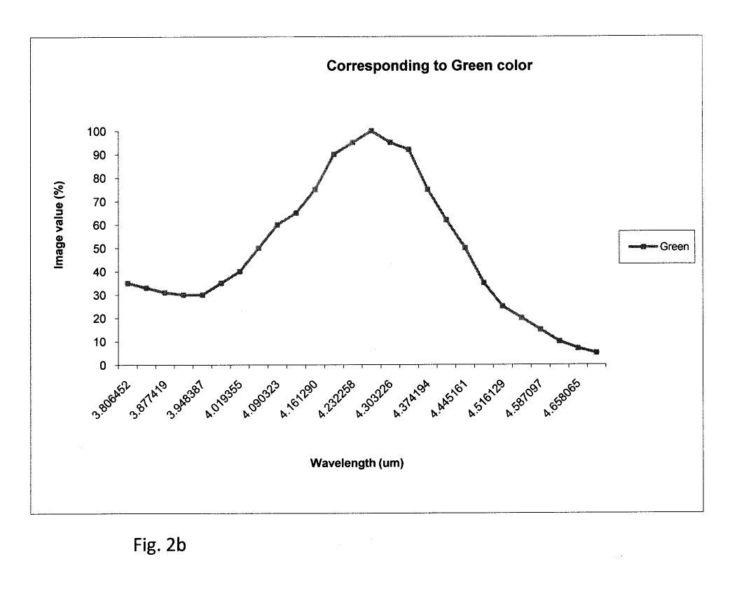

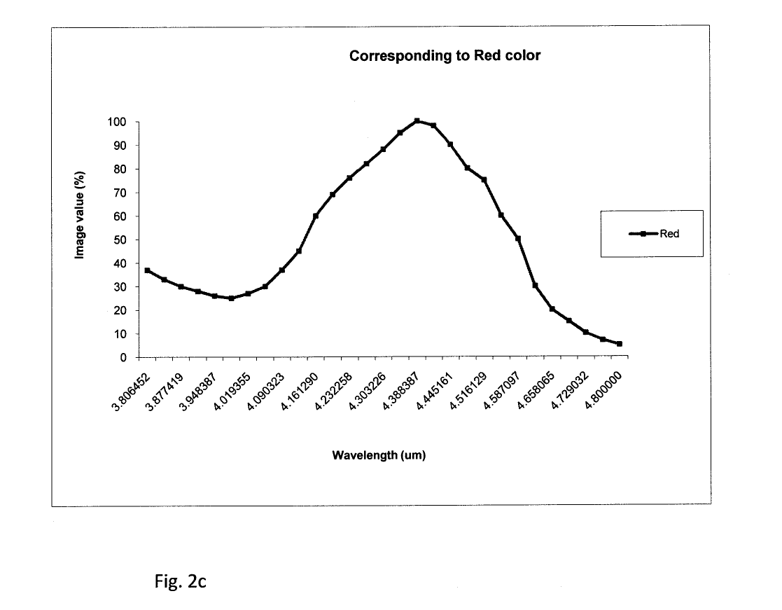

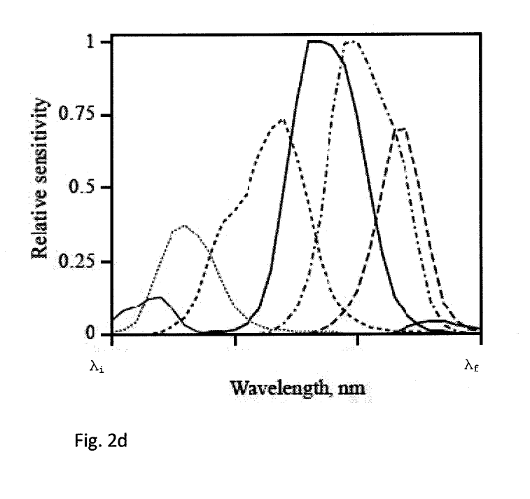

In one embodiment, the predetermined spectral components correspond to a response to a non-visible analogue to a visible spectrum representation of the number of predetermined spectral components. Multispectral image capture has been applied in color reproduction. The visible spectrum representation utilizing a number of spectral components can be obtained, in one instance, these teachings not being limited to only that instance, from eigenvectors of the color representation (see, for example, T. Jaaskelainen, J. Parkkinen, and S. Toyooka, “Vector-subspace model for color representation,” J. Opt. Soc. Am. A 7, 725-730 (1990); L. T. Maloney, “Evaluation of linear models of surface spectral reflectance with small numbers of parameters”, J. Opt. Soc. Am. A, vol. 10, pp. 1673-1683, 1986, both of which are incorporated by reference herein in their entirety and for all purposes), and in another instance, these teachings not being limited to only that instance, by principal component analysis (PCA) (see, for example, Kai Engelhardt and Peter Seitz, “Optimum color filters for CCD digital cameras,” Appl. Opt. 32, 3015-3023 (1993); M. J. Vrhel, H. J. Trussell, Color correction using principal components, Color Research & Application, Volume 17, Issue 5, pages 328-338, October 1992, both of which are incorporated by reference herein in their entirety and for all purposes). In one instance, not a limitation of these teachings a seven spectral component representation of the visible spectrum has been utilized (see, for example, R. S. Berns, F. H. Imai, P. D. Burns and D. Tzeng, Multispectral-based color reproduction research at the Munsell Color Science Laboratory, Proc. SPIE Europto Series 3409, Zürich, pp. 14-25. (1998), which is incorporated by reference herein in its entirety for all purposes). The nonvisible analogue of the seven component representation of the visible spectrum is shown in FIG. 2d, where the spectral range is denoted by λᵢ to λ_{f}, where λᵢ and λ_{f} are wavelengths in the non-visible range of the electromagnetic spectrum, for example, but not limited to, the terahertz radiation range or date infrared radiation range.

In one embodiment, the received electromagnetic radiation is in a terahertz radiation range of about 0.2 Terahertz (THz) to about 5 THz in frequency, corresponding to about 0.06 mm to about 1.5 mm in wavelength. In one instance, the received electromagnetic radiation is in a range of about 1.8 THz to about 2.8 THz in wavelength, corresponding to a range of about 107 microns (μ) (λᵢ) to about 161μ (λ_{f}) in wavelength. In another instance, the received electromagnetic radiation is in a range of about 0.2 THz to about 0.3 THz in wavelength, corresponding to a range of about 1 mm (λᵢ) to about 1.5 mm (λ_{f}) in wavelength. In yet another instance, the received electromagnetic radiation is in a range of about 0.5 THz to about 5.0 THz in wavelength, corresponding to a range of about 0.06 mm (λᵢ) to about 0.6 mm (λ_{f}) in wavelength. In another embodiment, the received electromagnetic radiation is in a far infrared range of about 8 microns (λᵢ) to about 14 microns (λ_{f}) in wavelength and the number of predetermined spectral components is more than three. For the above described instances and embodiments, a maximum of at least one component from one or more of the number of predetermined spectral components corresponding to response to a non-visible analogue to a visible spectrum representation of one or more of the number of predetermined spectral components, the visible spectrum representation of the one or more components corresponding to visible intensity, is chosen at a wavelength that allows increasing a detected radiation difference between a concealed object and the body. In one instance, not a limitation of these teachings, the one or more components corresponding to visual intensity can be identified by mapping the number of predetermined spectral components to tristimulus (RGB) values, where the green value is indicative of intensity, or to another color space, such as, for example, XYZ, L*a*b* or L*u*v* color spaces (see, for example, Wyszecki, Günther; Stiles, W. S. (1982). Color Science: Concepts and Methods, Quantitative Data and Formulae (2nd ed. ed.). New York: Wiley Series in Pure and Applied Optics. ISBN 0-471-02106-7, pp. 139, 164-167, incorporated by reference herein in its entirety for all purposes), where Y or L* are indicative of intensity. The one or more components that substantially contribute (or are the strongest contributors) to the indicators of intensity are selected and the maximum value is chosen as described above.

In order to elucidate the present teachings, the exemplary embodiments in which the number of component is three and the components are analogue to the spectral sensitivities of the cone types or the tristimulus spectral sensitivities are disclosed in more detail below. It should be noted that the exemplary embodiment is presented for elucidation and is not a limitation of these teachings. While in the exemplary embodiments disclosed below the image display is implemented by the RGB components, other implementations are possible for the multispectral representation (see, for example, R. S. Berns, F. H. Imai, P. D. Burns and D. Tzeng, Multispectral-based color reproduction research at the Munsell Color Science Laboratory, Proc. SPIE Europto Series 3409, Zürich, pp. 14-25. (1998)).

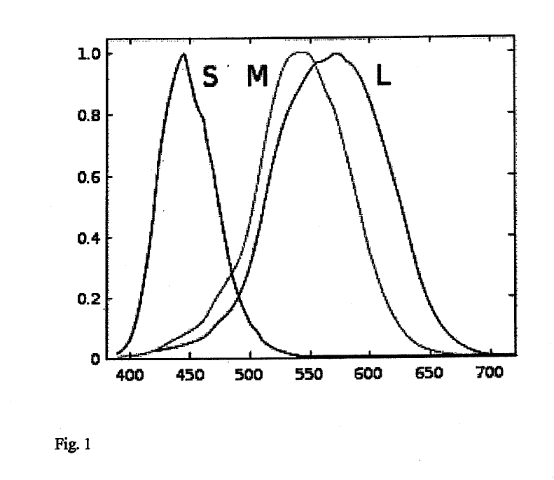

In one instance of the system and method of these teachings, significant thermal resolution improvement, in one exemplary embodiment hundreds time (not a limitation of these teachings), is achieved by utilizing an analogue, in the terahertz radiation range or in the infrared radiation range, of the spectral sensitivities of the cone types (although the spectral decomposition is referred to as the spectral sensitivity of the cone types, other representations of these three components of the human vision spectral response, such as tristimulus values, are also within the scope of these teachings) providing a conversion wavelength to color analogous to the manner in which human eye perceives color. (Responses to transmitted or reflected infrared radiation which are analogous to the response of the human eye are also disclosed in U.S. Pat. No. 5,321,265, issued to Block on Jun. 14, 1994, which is incorporated by reference herein in its entirety.) FIG. 1 shows the conventional spectral sensitivities of the of the cones-short (S), medium (M), and long (L) cone types, also sometimes referred to as blue, green, and red cones). In one embodiment, three filter shapes, in the terahertz radiation range, analogous to the spectral sensitivities in the human eye (shown in FIGS. 2a, 2b, 2c) are utilized.

In one instance and in one exemplary embodiment disclosed herein below, far infrared, about 8 to about 14 microns, is used because there are multiple uncooled and relatively inexpensive infrared detectors (cameras) available and the substantial maximum of body radiation is around 9.5 microns. Other infrared or other electromagnetic radiation ranges could be used.

In another instance, received electromagnetic radiation is in a terahertz radiation range of about 0.2 Terahertz (THz) to about 5 THz in frequency, corresponding to about 0.06 mm to about 1.5 mm in wavelength. In one embodiment, the received electromagnetic radiation is in a range of about 1.8 THz to about 2.8 THz in wavelength, corresponding to a range of about 107 microns (μ) to about 161μ in wavelength, and a maximum of the filter separating the component corresponding to a response to a non-visible analogue to a green component of human vision spectral sensitivity is located at about 138.7μ. In another embodiment, the received electromagnetic radiation is in a range of about 0.2 THz to about 0.3 THz in wavelength, corresponding to a range of about 1 mm to about 1.5 mm in wavelength, and a maximum of the filter separating the component corresponding to a response to a non-visible analogue to a green component of human vision spectral sensitivity is chosen at a wavelength that allows increasing a detected radiation difference between a concealed object and the body. In yet another embodiment, the received electromagnetic radiation is in a range of about 0.5 THz to about 5.0 THz in wavelength, corresponding to a range of about 0.06 mm to about 0.6 mm in wavelength, and a maximum of the filter separating the component corresponding to a response to a non-visible analogue to a green component of human vision spectral sensitivity is chosen at a wavelength that allows increasing a detected radiation difference between a concealed object and the body.

However, it should be noted that the present teachings are not limited to the infrared range or the above terahertz embodiments. Other embodiments utilizing other frequency ranges of the observed electromagnetic radiation are within the scope of these teachings.

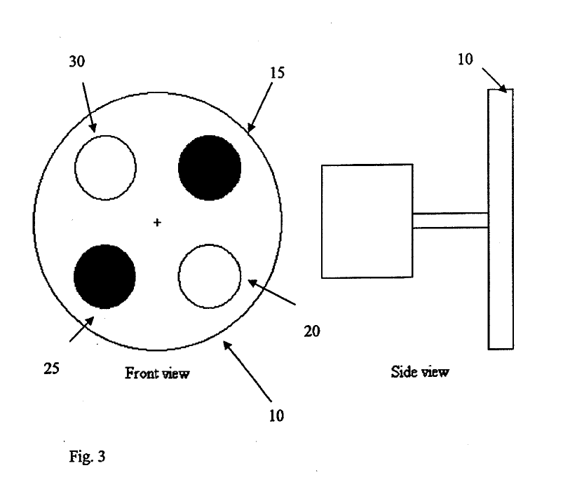

In most instances, an object attached to the human body has less temperature than the body around the object. As a result, in those instances, radiation from the object is less than radiation from the body around the object. Based on this characteristic, in one embodiment, spectral decomposition subsystems (filters in the embodiment shown in FIG. 3, these teachings is not being limited only to that embodiment; other spectral decomposition subsystems are within the scope of these teachings) are chosen to increase the radiation differences and distinguish the object better (that is, with the substantially best possible contrast). For example, there are almost no chemical groups in Nature which absorb and then reemit the radiation in the range 10-11 micron. As a result, in the spectral window between 8-14 micron, the object has a substantially minimal radiation in the range 10-11 micron and this fact can be used in selecting the maximum value of the infrared filter analogous to the visible green spectral decomposition.

Because the human eye is more sensitive to the green color, and the green color is lighter than the blue and red colors, the analogous green filter, for the infrared range of about 8 to about 14 microns, is chosen as having a maximum around 10.5 microns. The analogous green filter shown in FIG. 2 is shifted somewhat to the left of an exact analogue of the spectral sensitivities of FIG. 1.

With the analogue green filter maximum around substantially 10.5 microns and analogue blue-red filters as shown in FIG. 2, around the object on the human body, an infrared camera will observe substantially the whole spectrum of the body radiation. (Although the term “filters” is used herein and below, other methods of achieving the equivalent spectral decomposition are within the scope of these teachings.) All of these three filters will significant contribute to the corresponding images. When provided to the display, the output of the filter in FIG. 2 analogous to the green sensitivity is provided as the green signal in RGB.

For other frequency ranges, the maximum of the analogous green filter is chosen at a wavelength that allows increasing the detected radiation difference between the concealed object and the body. For example, in the embodiment utilizing the terahertz radiation range of about 1.8 THz to about 2.8 THz in wavelength, a maximum of the filter separating the component corresponding to a response to a non-visible analogue to a green component of human vision spectral sensitivity is located at about 138.7μ. Similarly the output of the filters analogous to red and blue sensitivities are provided as the red and blue signals in RGB. In one instance, overlay of the images obtained with the different analogous filters would give bright and close to yellow color of the body around the object.

At the same time, for the infrared range of about 8 to about 14 microns, there would be smallest radiation from the object in the spectral window 10-11 micron with green color and significantly more radiation in the range 8-10 micron with blue color and in the range 11-14 micron with red color. The image obtained by overlay of the three images would have substantially no yellow color and would look significantly darker on the object than body around the object.

One embodiment of the filter assembly of these teachings is shown in FIG. 3. Referring to FIG. 3, shown therein is a rotating disk 10 before the terahertz radiation detector (referred to as a camera) with three filters (analogous to red 15, analogous to green 20, analogous to blue 25) and a transparent filter 30, in one instance, an empty hole, (to receive raw temperature image). Triplets of images are provided to the computer software that converts terahertz radiation triplets to the color image presented to the operator after image processing based on contrast improvement.

Although, in the embodiment shown in FIG. 3, the spectral decomposition subsystem includes the movable (rotating in one embodiment, translation also being within the scope of these teachings) disc with three filters, a number of other embodiments also within the scope of these teachings. In one instance, the color filters can be implemented on the image acquisition device itself, as in the Bayer filters disclosed in U.S. Pat. No. 3,971,065 the image acquisition device (detector) disclosed in US patent application publication 20070145273, entitled “High-sensitivity infrared color camera”, or in U.S. Pat. No. 7,138,663, all of which are incorporated by reference herein in their entirety. In other embodiments, a measurement of the spectrum is obtained at a number of pixels using conventional means and each spectrum is decomposed into tri-stimulus values, for example, as disclosed in W. K. Pratt, Digital Image Processing, ISBN0-471-01888-0, pp. 457-461, which is incorporated by reference herein in its entirety.

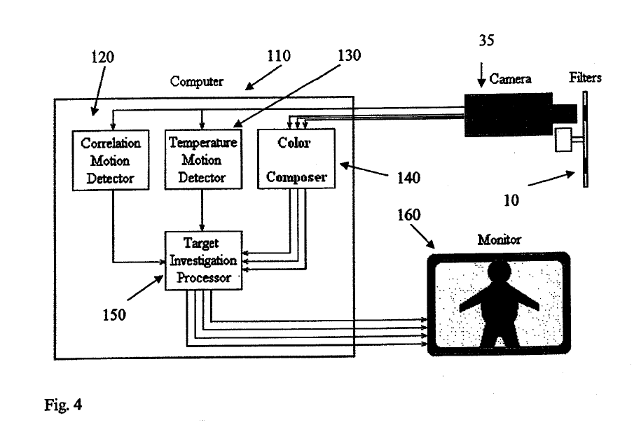

An embodiment of the system of these teachings is shown in FIG. 4. Referring to FIG. 4, four signals are provided by the camera 35, each signal corresponding to an image filtered by one of the four filters, a transparent filter (producing an image referred to as a raw image or raw pixels), and filters analogous to red, green, and blue, as described hereinabove.

The system shown in FIG. 4 includes an image acquisition subsystem 35 receiving electromagnetic radiation from a body, a spectral decomposition subsystem 10 separating the received electromagnetic radiation into at least three components, each one component of three of the at least three components corresponding to a response to a non-visible analogue to one human vision spectral response from three human vision spectral responses and an analysis subsystem 110 receiving the at least three components, identifying at least one region in an image obtained from at least one the at least three components and providing a color image, the color image obtained from a visible equivalent of the non-visible analogue; the at least one region of the color image enabling detection of a concealed object.

In the embodiment shown in FIG. 4, the spectral decomposition subsystem also provides a substantially unattenuated image (such as that obtained by a clear filter and also referred to as a “raw” image) and the electromagnetic radiation detected is in the terahertz radiation range. The image pixels are, in one embodiment, provided to two analysis subsystems, referred to as “Motion detectors,” 120, 130 based on two principles: correlation and temperature. (It should be noted that motion need not be detected in the subsystems labeled as “motion detectors” 120, 130. The term “motion detector” is used herein for continuity with the priority document. It should also be noted that the use of the term detector in “motion detector” should not be confused with the term detector referring to a device, such as a camera, CCD, etc., used to acquire an image.) Signals from these “detectors” extract an image of a body that has been observed by the image acquisition device and remove the background allowing an increase in contrast of the body and the concealed object.

Three “color” signals, for example, in the infrared range or in the terahertz radiation range, are provided to a Color Composer 140 that creates a color image (corresponding to the three analogous filtered images), as disclosed herein above. In one instance, the color image is a color image of substantially only the extracted body. A Target Investigation Processor 150 sends the extracted part of the color image to the monitor and an observer (operator) can extract or recognize, due to the use of color, the concealed object although there is an almost negligible temperature difference between the concealed object and the body.

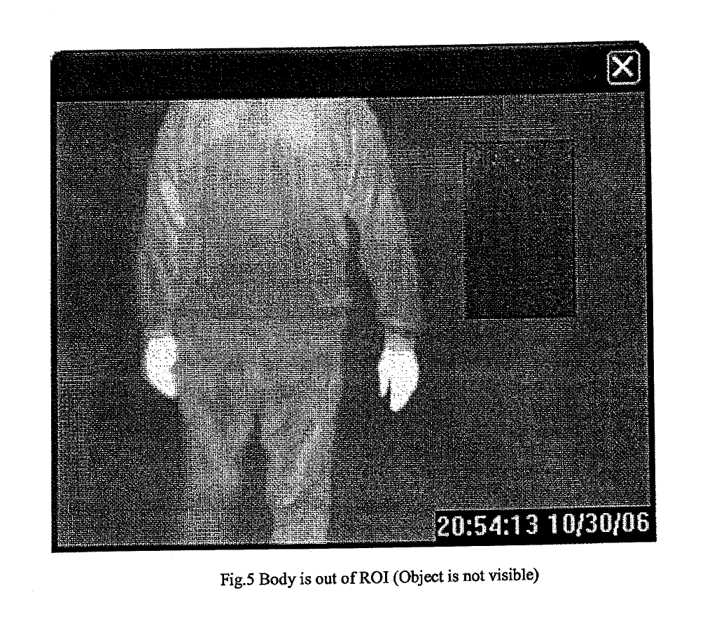

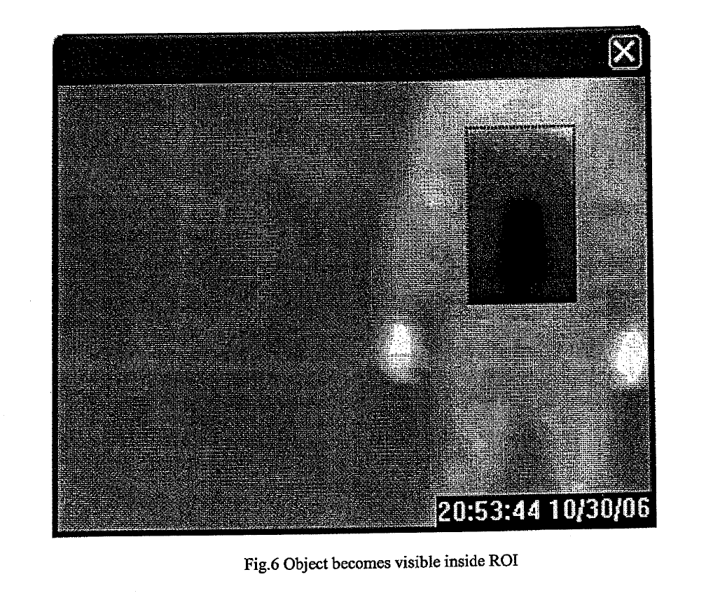

FIGS. 5 and 6 illustrate the results from a Temperature contrastor (internal to the Temperature Motion Detector 130) in an infrared image. The concealed Object becomes visible after body is coming under ROI (Region Of Interest) of a Contrast detector. Exemplary embodiments of contrast detection and related image processing techniques can be found in, but not limited to, US Patent publication number 20070122038, Methods and systems for detecting concealed objects, and in WIPO patent publication number WO2006093755, METHODS AND SYSTEMS FOR DETECTING PRESENCE OF MATERIALS, both of which are incorporated by reference herein in their entirety.

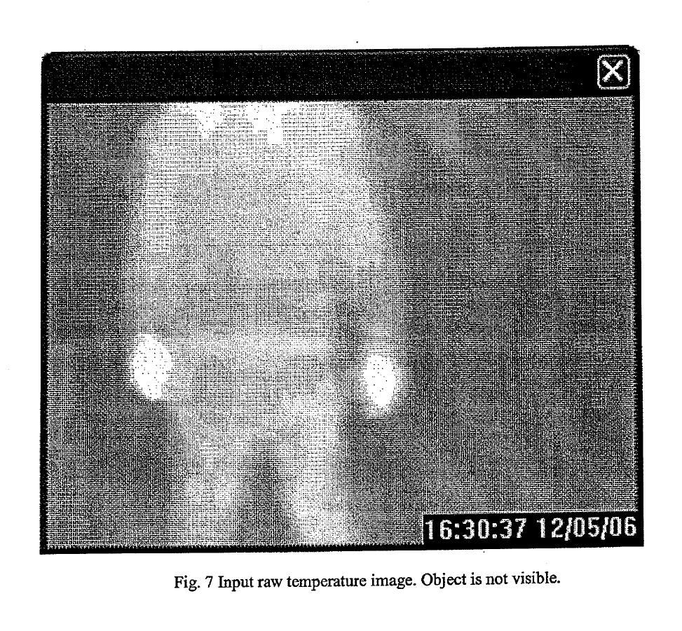

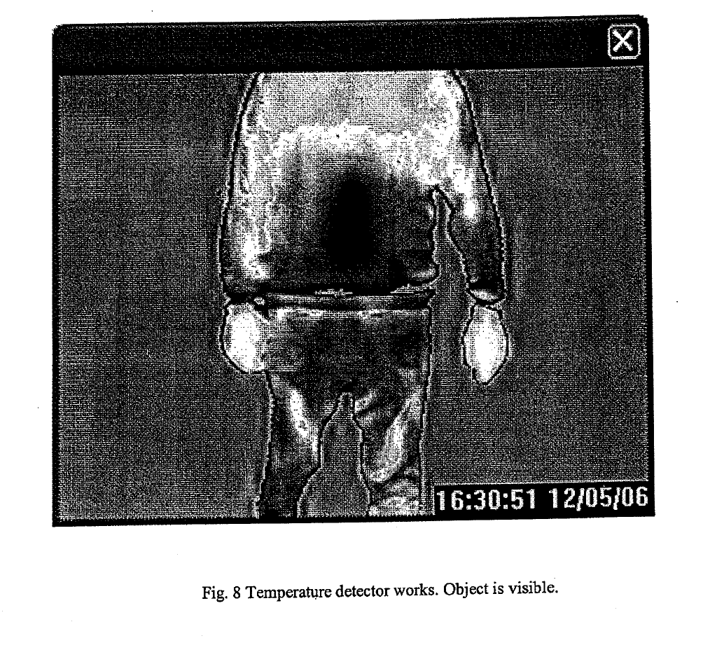

FIGS. 7 and 8 illustrate the results obtained from the Temperature Motion Detector 130.

In the embodiment shown in FIG. 4, from the raw (substantially unfiltered) image, such as that in FIG. 7, a region of interest can be selected including substantially and mostly the region with increased intensity (corresponding to increased temperature) and that comprises the body. (In one instance, the region can be selected by techniques such as, but not limited to, edge detection.) The selected region has, on the average, an intensity (temperature) that is indicative of the body. Contrast enhancement, and/or other techniques, can be applied to the selected region in order to obtain results such as those shown in FIG. 8.

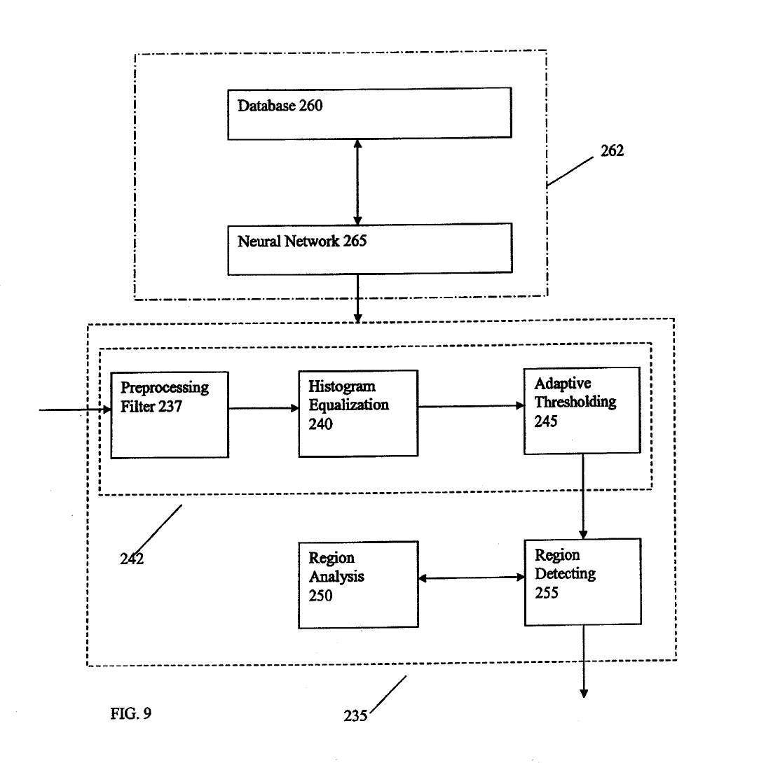

Application of the contrast detection and related image processing techniques disclosed in US Patent publication number 20070122038 to the embodiment shown in FIG. 4 is shown in FIG. 9 (from FIG. 3 of US Patent publication number 20070122038). Referring to FIG. 9, the system shown therein also includes an analysis component 235 receiving one or more images from the one or more image acquisition devices 35. The analysis component 235 is capable of identifying one or more regions in the one or more images. The color image, obtained from the target image processor 150, having the one or more regions identified is then provided to the display 160.

In one instance, the analysis component 235 is also capable of enhancing an image attribute in the one or more regions. Exemplary embodiments of the image attribute are, but this invention is not limited only to this embodiments, contrast or color.

Referring to FIG. 9, the embodiment shown therein includes a pre-processing component 242 capable of enhancing detectability of the one or more regions in the one or more images received from the acquisition device 35. The embodiment shown in FIG. 9 also includes a region detecting component 255 capable of identifying the one or more regions in the one or more preprocessed images and a region analysis component 250 capable of determining characteristics of the one or more regions. In one instance, but this invention is not limited to only this embodiment, the characteristics include moment invariants.

In the embodiment shown in FIG. 9, the preprocessing component 242 includes a noise reduction component 237 capable of increasing a signal to noise ratio in the one or more images and a contrast enhancing component. The contrast enhancing component, in the embodiment shown in FIG. 9, includes a histogram equalization component 240 (see, for example, W. K. Pratt, Digital image Processing, ISBN0-471-01888-0, pp. 311-318, which is incorporated by reference herein in its entirety) and an adaptive thresholding component 245 capable of binarizing an output of the histogram equalization component 240. (For adaptive thresholding, see, for example, but not limited to, Ø.D. Trier and T. Taxt, Evaluation of binarization methods for document images, available at http://citeseer.nj.nec.com/trier95evaluation.html, also a short version published in IEEE Transaction on Pattern Analysis and Machine Intelligence, 17, pp. 312-315, 1995, both of which are incorporated by reference herein in their entirety.) it should be noted that histograms can also be used for segmentation, and therefore for detecting a region. In one embodiment, the binary output of the histogram equalization component is downsampled to obtain a downsampled image (in order to save processing time of the region detecting component 255). In one instance, the noise reduction component 237 is an adaptive noise reduction filter such as, but not limited to, a wavelet based noise reduction filter (see, for example, Mukesh Motwani, Mukesh Gadiya, Rakhi Motwani, and Frederick C. Harris, Jr., “A Survey of Image Denoising Techniques,” in Proceedings of GSPx 2004, Sep. 27-30, 2004, Santa Clara Convention Center, Santa Clara, Calif., and Scheunders P., Denoising of multispectral images using wavelet thresholding.—Proceedings of the SPIE Image and Signal Processing for Remote Sensing IX, 2003, p. 28-35, both of which are incorporated by reference herein).

In one instance of the embodiment shown in FIG. 9, the region detecting component 255 includes segmentation to identify the one or more regions. (See for example, but not limited to, Ch. 9, Image Segmentation, in Handbook of Pattern Recognition and Image Processing, ISBN 0-121-774560-2, which is incorporated by reference herein in its entirety, C. Kervrann and F. Heitz, “A Markov random field model based approach to unsupervised texture segmentation using local and global spatial statistics,” IEEE Transactions on Image Processing, vol. 4, no. 6, 1995, 856-862, http://citeseer.ist.psu.edu/kervrann93markov.html, which is incorporated by reference herein in its entirety, and S. Liapis and E. Sifakis and G. Tziritas, “Colour and Texture Segmentation Using Wavelet Frame Analysis, Deterministic Relaxation, and Fast Marching Algorithms,” http://citeseer.ist.psu.edu/liapis04colour.html, which is incorporated by reference herein in its entirety.) In one embodiment, the region detecting component 255 labels each connective area (region) by unique label. Each region labeled is processed by the region analysis component 250 in order to determine shape characteristics (moment invariants, in one embodiment).

In one instance of the embodiment shown in FIG. 9, in the region analysis component 250, the characteristics include moment invariants (see for example, Keyes, Laura and Winstanley, Adam C. (2001) USING MOMENT INVARIANTS FOR CLASSIFYING SHAPES ON LARGE_SCALE MAPS. Computers, Environment and Urban Systems 25. available at http://eprints.may.ie/archive/00000064/, which is incorporated by reference herein in its entirety). In the embodiment in which shape characteristics are important for object detection, the moments will identify concealed objects. (For example, circled objects have all moments starting from the second equal zero. Symmetrical objects have specific moments, etc.) Other embodiments of the characteristics obtained from the region analysis component 50 include, but are not limited to, multiscale fractal dimension and contour saliences, obtained using the image foresting transform, fractal dimension and Fourier descriptors (see for example, R. Torres, A. Falcao, and L. Costa. A graph-based approach for multiscale shape analysis. Pattern Recognition, 37(6):1163-1174, 2004, available at http://citeseer.ist.psu.edu/torres03graphbased.html, which is incorporated by reference herein in its entirety).

In one instance, if a region with given characteristics (a given moment) values is detected, the region provided to the one or more displays 60 is enhanced by contrast.

In one instance, in the embodiments described above, some of the elements of the analysis component 235, such as, but not limited to, the noise reduction filter 237, histogram equalization component 240, the adaptive thresholding component 45, or/and the unsupervised segmentation component 255, are adaptive. Adaptation can be accomplished or enhanced by means of an adaptation component 262. In one embodiment, the adaptation component 62 includes a database 60 (in one instance, a computer usable medium for storing data for access by a computer readable code, the computer usable medium including a data structure stored in the computer usable medium, the data structure including information resident in a database, referred to as “a database”) and a neural network component 265. It should be noted that although the embodiment shown in FIG. 9 utilizes a neural network for the adaptation (including optimizing of parameters), other methods of optimization are also within the scope of this invention. The adaptation component 262 can, in one embodiment, include a component utilizing artificial intelligence or decision logic (including fuzzy decision logic). In one embodiment, substantially optimal parameters of some of the elements of the analysis component 235, such as, but not limited to, the noise reduction filter 237, histogram equalization component 240, the adaptive thresholding component 245, or/and the unsupervised segmentation component 255, are determined (within a training procedure) by means of the neural network 265 and the database 60.

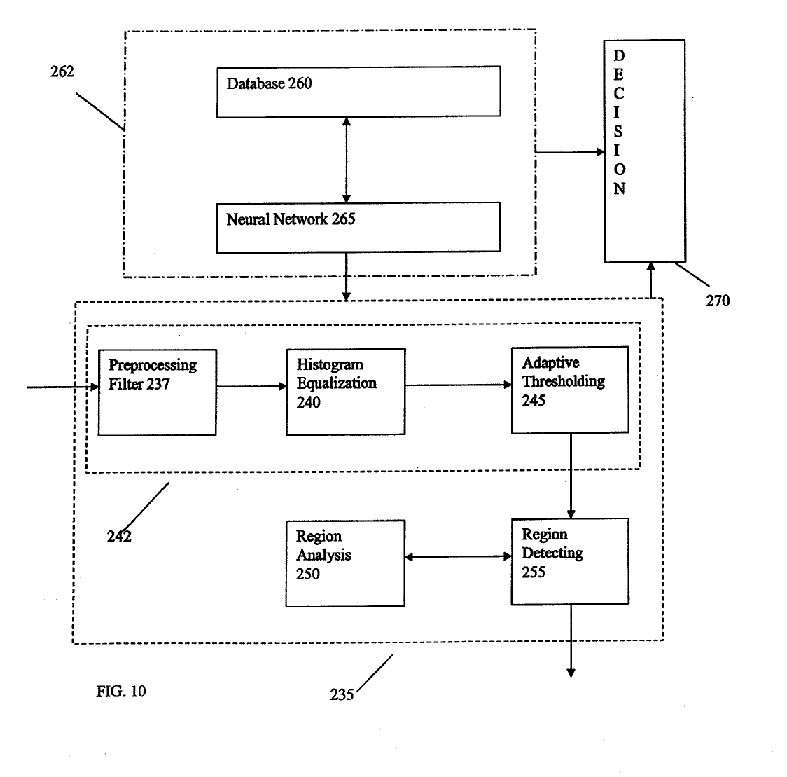

FIG. 10 (from FIG. 4 of US Patent publication number 20070122038) shows another block diagram representation of an embodiment of the analysis component 235. Referring to FIG. 10, the output of the region processing component 255 including the shape characteristics (moment invariants) and input from an optimizing component (the neural network) and the database are provided to a decision component 270. The decision component 270 can be, but is not limited to, a component utilizing artificial intelligence or another neural network or decision logic (including fuzzy decision logic) (see for example, O. D. Trier, A. K. Jain and T. Taxt, “Feature extraction methods for character recognition—A survey,” Pattern Recognition 29, pp. 641-662, 1996, available at http://citeseer.ist.psu.edu/trier95feature.html, which is incorporated by reference herein in its entirety, Fernando Cesar C. De Castro et al, “Invariant Pattern Recognition of 2D Images Using Neural Networks and Frequency-Domain Representation,” available at http://citeseer.ist.psu.edu/29898.html, which is also incorporated by reference herein in its entirety). The decision component 270, in one embodiment, can supplement or replace the display 160.

It should be noted that the above disclosed techniques are presented to give a range of options available in detecting a region, not all the above techniques need to be applied in a single embodiment. Combinations of the above disclosed techniques can also be utilized.

Referring again to FIG. 4, the correlation motion detector 120 also receives the raw image. As in the temperature motion detector 130, from the raw (substantially unfiltered) image, a region of interest can be selected including substantially and mostly the region with increased intensity (corresponding to increased temperature) and that comprises the body. The image of that selected region of interest can be utilized in subsequent raw images in order to identify the body (and concealed object) by selecting the region that substantially maximizes the correlation with the image of the previously selected region. The combination of the correlation motion detector 120 and the temperature motion detector 130 can be used to identify the body (and concealed object) and extract a part of the image corresponding to substantially the body in subsequent images. The combination of the correlation motion detector 120 and the temperature motion detector 130 can also be utilized to extract a part of the image corresponding to substantially the body (and concealed object) and to substantially remove the background. (In one instance, both the correlation and the identified region of enhanced temperature can be used to extract the part of the image corresponding substantially to the body and concealed object.) After the background as the substantially removed from the extracted image, the contrast between the body and the concealed object can be enhanced.

In one embodiment, the two “Motion detectors” 120, 130, the Color Composer 140, and the Target Investigation Processor 150 are implemented by means of one or more processors and one or more computer usable media having computer readable code embodied therein that causes the one or more processors to perform the functions of the two “Motion detectors” 120, 130, the Color Composer 140, and the Target Investigation Processor 150. This implementation is labeled as computer 110 in FIG. 4.

Although in the embodiment described above the region of interest is selected from the substantially unfiltered (“raw”) image, embodiments of these teachings also include embodiments in which the temperature detector 130 and the correlation detector 120 are combined with the color composer 140. In those embodiments the region of interest is obtained by segmenting the color image (see for example, but not limited to, Coleman, G. B, Andrews, H. C., Image segmentation by clustering, Proceedings of the IEEE, Volume 67, Issue 5, May 1979 Page(s):773-785 and Lucchese, L., Mitra, S. K, Unsupervised segmentation of color images based on k-means clustering in the chromaticity plane, Proceedings. IEEE Workshop on Content-Based Access of Image and Video Libraries, 1999 (CBAIVL '99), 1999, Pages: 74-78, both of which incorporated by reference herein in their entirety, and references provided therein).

The image analysis subsystems, including the “correlation motion detector,” the “temperature motion detector” and the “color composer” can be implemented utilizing a computer readable code embodied in a computer usable or readable medium and one or more processors.

In the above described embodiments, the filter assembly of FIG. 3 or color filters implemented on the image acquisition device comprise means for separating electromagnetic radiation received from a body into at least three components, each one component of three of the at least three components corresponding to a response to a non-visible analogue to one human vision spectral response from three human vision spectral responses (a wavelength of the electromagnetic radiation being in a non-visible range). A camera, such as a camera or a detector such as in an infrared detector or a terahertz radiation detector (in one instance, in the infrared range, a device in which at every pixel a capacitance varies according to the received radiation) or any of a variety of image acquisition devices (such as CCD's in the infrared) comprise image acquisition means in the embodiments disclosed above. Examples of terahertz radiation detectors include, but are not limited to, Y. Cai et al., Coherent terahertz radiation detection: Direct comparison between free-space electro-optic sampling and antenna detection, Applied Physics Letters, Vol. 73, no. 4, 27 Jul. 1998, pp. 444-446; A. Sinyukov and L. M. Hayden, Generation and detection of terahertz radiation with multilayered electro-optic polymer films, OPTICS LETTERS, Vol. 27, No. 1, Jan. 1, 2002, pp. 55-57; S. Boubanga-Tombet et al., Terahertz Radiation Detection by Field Effect Transistor in Magnetic Field, available at arXiv:0904.2081v1 [cond-mat.mes-hall] (Submitted on 14 Apr. 2009), all of which are Incorporated by reference herein in their entirety for all purposes, and also diode lasers, high electron mobility transistors (HEMTs) and Si-CMOS based transistors.

One of the number of the region identification methods disclosed above and one or more processors or computer readable or usable media having computer readable code embodied therein that causes the one or more processors to implement the method comprise means for identifying at least one region in at least one image in the above described embodiments. One more processors and computer usable media having computer readable code embodied therein for receiving the number of predetermined components corresponding to a response to a non-visible analogue to a visible spectrum representation of said number of predetermined spectral components (in the exemplary embodiment, the three components corresponding to responses to a nonvisible analogue to the human vision spectral responses), converting the nonvisible analogue to the visible spectrum representation (in the exemplary embodiment, visible human vision spectral responses) and generating a color image comprise means for obtaining a color image in the above described embodiments.

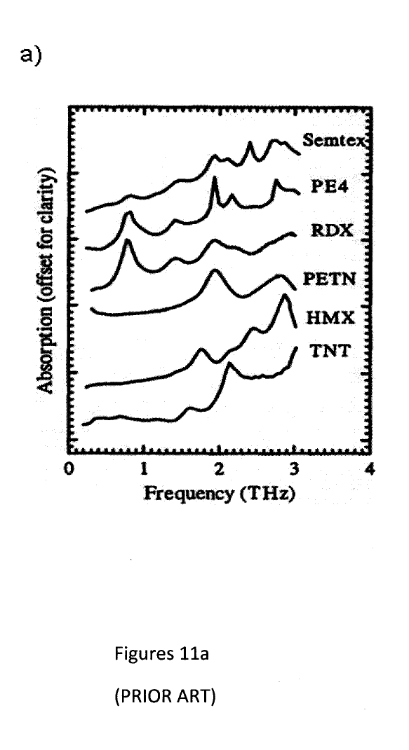

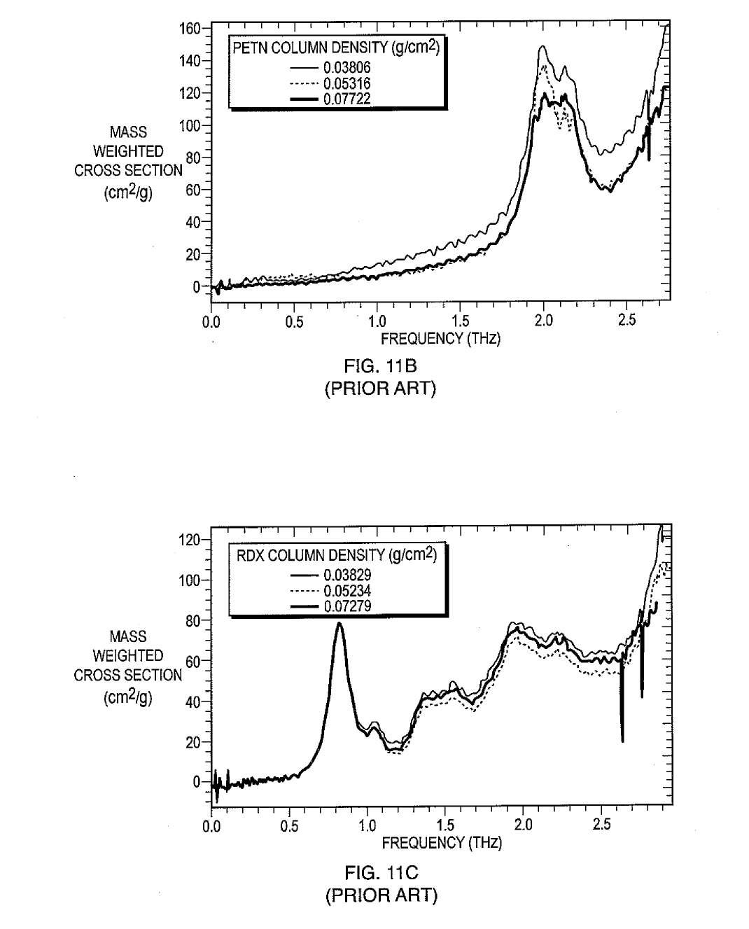

While the embodiments disclosed above have described generating the color image, it should be noted that in obtaining the nonvisible analogue of the number of predetermined spectral components, the spectrum of the concealed object in the non-visible range of electromagnetic radiation is also obtained. Once the spectrum of the concealed object in the non-visible range is obtained, the obtained spectrum can be compared to known spectra and the material of the concealed object can be identified. The method and system disclosed in U.S. Pat. No. 7,709,796, entitled METHODS AND SYSTEMS FOR DETECTING PRESENCE OF MATERIALS, issued on May 4, 2010 to I. Gorian et al., which is incorporated by reference herein in its entirety for all purposes, can be utilized to identify the material of the concealed object. Shown in FIGS. 11a, 11b and 11c, are graphical representations of the spectral characteristics of different explosives.

Fortuitously, the emissivity spectra for a compound material (a mixture), such as cotton fabric over polyethilene, is obtained by adding together in a simple linear fashion the emissivity spectra of the individual components of a compound material. In one instance, the emissivity spectra can be converted to an signature (such as a thermal signature in the infrared range). (The thermal signature is the apparent temperature for a given wavelength band. The apparent temperature of a surface is the temperature of a blackbody source having the same radiant emittance, averaged over a specified waveband, as the radiant emittance of the surface averaged over the same wavelength band.) In the exemplary embodiment, the filter assembly includes a number of filters, where each filter covers a wavelength band of interest. One of the filters is an un-attenuating or clear filter, which is used by the feature extraction component to obtain one or more regions. The physical characteristics of the extracted images of each region (extracted from the image resulting from transmissions through one of the filters, other than the un-attenuating filter) resulting from having applied the region as a mask can be expressed in terms of an apparent temperature. Each extracted image, corresponding to a wavelength band, can be compared to a thermal signature.

In one embodiment, the analysis component is also capable of obtaining characteristics of the at least one region in at least one predetermined image, the at least one predetermined image corresponding to transmission of electromagnetic radiation, emitted by the emitting body, through at least one predetermined filter from the number of filters, and of providing at least one image of the at least one region in the at least one predetermined image, a database of wavelength spectrum data corresponding to at least one predetermined material, and the detection component is also capable of receiving the image of the one or more regions of interest in the other predetermined image and the wavelength spectrum data from the database and also capable of detecting presence of the one or more predetermined materials.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Elements and components described herein may be further divided into additional components or joined together to form fewer components for performing the same functions.

Each computer program may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable media include, for example, a floppy disk, a flexible disk, hard disk, magnetic tape, or any other magnetic medium, a CDROM, any other optical medium, any physical medium with patterns of holes, a RAM, a PROM, and EPROM, a FLASH-EPROM, any other memory chip or cartridge, all of which are non-transitory. As stated in the USPTO 2005 Interim Guidelines for Examination of Patent Applications for Patent Subject Matter Eligibility, 1300 Off. Gaz. Pat. Office 142 (Nov. 22, 2005), “On the other hand, from a technological standpoint, a signal encoded with functional descriptive material is similar to a computer-readable memory encoded with functional descriptive material, in that they both create a functional interrelationship with a computer. In other words, a computer is able to execute the encoded functions, regardless of whether the format is a disk or a signal.”

It should be noted that although the present teachings are illustrated by an exemplary embodiment operating in given ranges of electromagnetic radiation, the present teachings are not limited only to those embodiments.

Although these teachings have been described with respect to various embodiments, it should be realized these teachings is also capable of a wide variety of further and other embodiments within the spirit and scope of the appended claims.

What is claimed is:

1. A system for detecting concealed objects, the system comprising:
a spectral decomposition subsystem receiving electromagnetic radiation from a body and separating the received electromagnetic radiation into at least a number of predetermined spectral components, each one component from said number of predetermined components corresponding to a response to a non-visible analogue to a visible spectrum representation of said number of predetermined spectral components; a wavelength of said received electromagnetic radiation being in a non-visible range;
an image acquisition sub-system receiving electromagnetic radiation from the spectral decomposition subsystem; and
an analysis subsystem receiving said at least a number of predetermined spectral components, identifying at least one region in an image obtained from at least one of said number of predetermined spectral components and providing a color image, the color image obtained from the visible spectrum representation of the non-visible analogue; the at least one region of the color image enabling detection of a concealed object.

2. The system of claim 1 wherein said number of predetermined spectral components comprises three predetermined components, each one component of said three predetermined components corresponding to a response to a non-visible analogue to one human vision spectral response from three human vision spectral responses; and wherein said received electromagnetic radiation is in a terahertz radiation range of about 0.2 Terahertz (THz) to about 5 THz in frequency, corresponding to about 0.06 mm to about 1.5 mm in wavelength.

3. The system of claim 2 wherein the received electromagnetic radiation is in a range of about 1.8 THz to about 2.8 THz in wavelength, corresponding to a range of about 107 microns (μ) to about 161μ in wavelength.

4. The system of claim 3 wherein a maximum of a filter separating one component of said at least three predetermined components corresponding to a response to a non-visible analogue to a green component of human vision spectral sensitivity is located at about 138.7μ.

5. The system of claim 2 wherein the received electromagnetic radiation is in a range of about 0.2 THz to about 0.3 THz in wavelength, corresponding to a range of about 1 mm to about 1.5 mm in wavelength.

6. The system of claim 5 wherein a maximum of a filter separating one component of said at least three predetermined components, said one component corresponding to a response to a non-visible analogue to a green component of human vision spectral sensitivity, is chosen at a wavelength that allows increasing a detected radiation difference between a concealed object and the body.

7. The system of claim 2 wherein the received electromagnetic radiation is in a range of about 0.5 THz to about 5.0 THz in wavelength, corresponding to a range of about 0.06 mm to about 0.6 mm in wavelength.

8. The system of claim 7 wherein a maximum of a filter separating one component of said at least three predetermined components, said one component corresponding to a response to a non-visible analogue to a green component of human vision spectral sensitivity, is chosen at a wavelength that allows increasing a detected radiation difference between a concealed object and the body.

9. The system of claim 1 wherein said spectral decomposition subsystem comprises a filter assembly comprising a number of filters equal to at least said number of predetermined spectral components, said filter assembly movable to place one of said filters in an optical path between the body and said image acquisition sub-system; each one filter of said filters from said a number of filters equal to said number of predetermined spectral components substantially corresponding to the non-visible analogue of a visible spectrum representation of said number of predetermined spectral components.

10. The system of claim 1 wherein said analysis subsystem further comprises:
a region detecting component identifying at least one regions in an image obtained from an output of said image acquisition sub-system.

11. The system of claim 10 wherein said spectral decomposition subsystem separates the received electromagnetic radiation into four components, said fourth component being substantially unattenuated; and wherein said image is obtained from said substantially unattenuated component.

12. The system of claim 10 wherein said analysis subsystem comprises a contrast detection subsystem; said contrast detection subsystem comprising said region detecting component.

13. The system of claim 12 wherein said analysis subsystem further comprises a correlation subsystem; said correlation subsystem also receiving said image; said correlation subsystem obtaining a correlation of said at least one region with subsequently acquired images.

14. The system of claim 1 wherein the received electromagnetic radiation is in a range of about 1.8 THz to about 2.8 THz in wavelength, corresponding to a range of about 107 microns (μ) to about 161μ in wavelength.

15. The system of claim 14 wherein a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, is chosen at a wavelength that allows increasing a detected radiation difference between a concealed object and the body.

16. The system of claim 1 wherein the received electromagnetic radiation is in a range of about 0.2 THz to about 0.3 THz in wavelength, corresponding to a range of about 1 mm to about 1.5 mm in wavelength.

17. The system of claim 16 wherein a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, is chosen at a wavelength that allows increasing a detected radiation difference between a concealed object and the body.

18. The system of claim 1 wherein the received electromagnetic radiation is in a range of about 0.5 THz to about 5.0 THz in wavelength, corresponding to a range of about 0.06 mm to about 0.6 mm in wavelength.

19. The system of claim 18 wherein a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, is chosen at a wavelength that allows increasing a detected radiation difference between a concealed object and the body.

20. The system of claim 1 wherein the received electromagnetic radiation is in a far infrared range of about 8 to about 14 microns in wavelength; and wherein said number of predetermined spectral components comprises more than three components.

21. The system of claim 20 wherein a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, is chosen at a wavelength that allows increasing a detected radiation difference between a concealed object and the body.

22. A method for detecting concealed objects, the method comprising the steps of:
separating, utilizing a spectral decomposition device, electromagnetic radiation received from a body into a number of predetermined spectral components, each one component from said number of predetermined components corresponding to a response to a non-visible analogue to a visible spectrum representation of said number of predetermined spectral components; a wavelength of said received electromagnetic radiation being in a non-visible range;
acquiring, utilizing an image acquisition device, at least one image from the separated electromagnetic radiation;
identifying, utilizing an analysis subsystem, at least one region in the at least one image; and
obtaining a color image from a visible equivalent of the non-visible analogue to human vision spectral response;
the color image obtained from a visible equivalent of the non-visible analogue; the at least one region of the color image enabling detection of a concealed object.

23. The method of claim 22 wherein said number of predetermined spectral components comprises three predetermined components, each one component of said three predetermined components corresponding to a response to a non-visible analogue to one human vision spectral response from three human vision spectral responses.

24. The method of claim 23 wherein the step of separating electromagnetic radiation received from the body comprises the step of separating the received electromagnetic radiation into four components, the fourth component being substantially unattenuated; and wherein the at least one region is identified in an image obtained from the substantially unattenuated component.

25. The method of claim 23 wherein said received electromagnetic radiation is in a terahertz radiation range of about 0.2 Terahertz (THz) to about 5 THz in frequency, corresponding to about 0.06 mm to about 1.5 mm in wavelength.

26. The method of claim 25 wherein the received electromagnetic radiation is in a range of about 1.8 THz to about 2.8 THz in wavelength, corresponding to a range of about 107 microns (μ) to about 161μ in wavelength.

27. The method of claim 26 further comprising the step of selecting a maximum of a filter separating one component of said at least three predetermined components corresponding to a response to a non-visible analogue to a green component of human vision spectral sensitivity at about 138.7μ.

28. The method of claim 25 wherein the received electromagnetic radiation is in a range of about 0.2 THz to about 0.3 THz in wavelength, corresponding to a range of about 1 mm to about 1.5 mm in wavelength.

29. The method of claim 28 further comprising the step of selecting a maximum of a filter separating one component of said at least three predetermined components, said one component corresponding to a response to a non-visible analogue to a green component of human vision spectral sensitivity, at a wavelength that allows increasing a detected radiation difference between a concealed object and the body.

30. The method of claim 25 wherein the received electromagnetic radiation is in a range of about 0.5 THz to about 5.0 THz in wavelength, corresponding to a range of about 0.06 mm to about 0.6 mm in wavelength.

31. The method of claim 30 further comprising the step of selecting a maximum of a filter separating one component of said at least three predetermined components, said one component corresponding to a response to a non-visible analogue to a green component of human vision spectral sensitivity, at a wavelength that allows increasing a detected radiation difference between a concealed object and the body.

32. The method of claim 22 wherein the step of separating electromagnetic radiation received from the body comprises the step of providing a filter assembly; said filter assembly comprising at least a number of filters equal to at least said number of predetermined spectral components, said filter assembly movable to place one of said filters in an optical path between the body and said image acquisition sub-system; each one filter of said filters from said a number of filters equal to said number of predetermined spectral components substantially corresponding to the non-visible analogue of a visible spectrum representation of said number of predetermined spectral components.

33. The method of claim 22 wherein the step of identifying the at least one region comprises the step of detecting contrast in the image.

34. The method of claim 22 further comprises the step of obtaining a correlation of the at least one region with subsequently acquired images.

35. The method of claim 22 wherein the received electromagnetic radiation is in a range of about 1.8 THz to about 2.8 THz in wavelength, corresponding to a range of about 107 microns (μ) to about 161μ in wavelength.

36. The method of claim 35 further comprising the step of selecting a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, at a wavelength that allows increasing a detected radiation difference between a concealed object and the body.

37. The method of claim 22 wherein the received electromagnetic radiation is in a range of about 0.2 THz to about 0.3 THz in wavelength, corresponding to a range of about 1 mm to about 1.5 mm in wavelength.

38. The method of claim 37 further comprising the step of selecting a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, at a wavelength that allows increasing a detected radiation difference between a concealed object and the body.

39. The method of claim 22 wherein the received electromagnetic radiation is in a range of about 0.5 THz to about 5.0 THz in wavelength, corresponding to a range of about 0.06 mm to about 0.6 mm in wavelength.

40. The method of claim 39 further comprising the step of selecting a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, at a wavelength that allows increasing a detected radiation difference between a concealed object and the body.

41. The method of claim 22 wherein the received electromagnetic radiation is in a far infrared range of about 8 to about 14 microns in wavelength; and wherein said number of predetermined spectral components comprises more than three components.

42. The method of claim 41 wherein a maximum of at least one component from one or more of said number of predetermined spectral components corresponding to response to a non-visible analogue to a visible spectrum representation of one or more said number of predetermined spectral components, said visible spectrum representation of said one or more components corresponding to visible intensity, is chosen at a wavelength that allows increasing a detected radiation difference between a concealed object and the body.

43. A system for detecting concealed objects, the system comprising:
means for separating electromagnetic radiation received from a body into a number of predetermined spectral components, each one component from said number of predetermined components corresponding to a response to a non-visible analogue to a visible spectrum representation of said number of predetermined spectral components; a wavelength of said received electromagnetic radiation being in a non-visible range;
means for acquiring at least one image from the separated electromagnetic radiation;
means for identifying at least one region in the at least one image; and
means for obtaining a color image from a visible equivalent of the non-visible analogue to human vision spectral response.
